(19) United States
(12) Patent Application Publication
(10) Pub. No.: US 2025/0130873 A1
(43) Pub. Date: Apr. 24, 2025

(54) METHOD AND DEVICE FOR PROCESSING AT LEAST A FIRST AND A SECOND COMPUTING OPERATION IN A COMPUTING UNIT

(71) Applicant: Robert Bosch GmbH, Stuttgart (DE)

(72) Inventor: Andreas Achtzehn, Oberstenfeld (DE)

(21) Appl. No.: 18/686,759

(22) PCT Filed: Jul. 14, 2022
(86) PCT No.: PCT/EP2022/069756

§ 371 Date: Feb. 26, 2024

(30) Foreign Application Priority Data
Aug. 31, 2021 (DE) 10 2021 209 509.7

(51) Int. Cl. G06F 9/54

(52) U.S. Cl. CPC G06F 9/543

(57) ABSTRACT

A method for processing a first and a second computing operation in a computing unit. First and second time intervals are provided for processing the first and second computing operations in the computing unit. The method comprises a step of recognizing that the second computing operation has been completed in the second time interval at a completion time before an end of the second time interval. The method includes a step of executing the first computing operation in the second time interval after the completion time. In addition or as an alternative, the method includes a step of recognizing that the first computing operation has been completed in the first time interval at a completion time before an end of the first time interval and a step of executing the second computing operation in the first time interval after the completion time.

### FIELD

The present invention is based on a device or a method for processing at least a first and a second computing operation in a computing unit. The present invention also relates to a computer program.

### BACKGROUND INFORMATION

Systems with real-time requirements use special methods of resource allocation (scheduling, in particular for the CPU, in order to ensure that tasks are completed within a deterministic, i.e., known and guaranteed, time period). In order to guarantee resource availability, budgets within which the tasks should be completed are defined in some scheduling methods. In addition to ensuring that the budgeted task has enough resources available (in particular time in a CPU), the budget definition is also used to prevent the potential interference (negative influence) between tasks by unexpected, more excessive use of the resource. This is to ensure that a task does not use so many resources that another task can no longer be completed.

### SUMMARY

The present invention provides a method, a device that uses this method, and a corresponding computer program. Advantageous example embodiments, developments and improvements of the device disclosed herein are made possible by the measures in the disclosure herein.

The present invention provides a method for processing at least a first and a second computing operation in a computing unit, wherein a first time interval is provided for processing the first computing operation in the computing unit and a second time interval different from the first time interval is provided for processing the second computing operation in the computing unit. According to an example embodiment of the present invention, the method has the following steps:
recognizing that the second computing operation has been completed in the second time interval at a completion time before an end of the second time interval; and
executing the first computing operation in the second time interval after the completion time; and/or
recognizing that the first computing operation has been completed in the first time interval at a completion time before an end of the first time interval; and
executing the second computing operation in the first time interval after the completion time.

A computing operation can be understood to mean a task to be solved numerically. In the description herein, a computing unit can be understood as a processor or controller that can be programmed to process or execute corresponding computing operations. In this way, different processing instructions can be executed as computing operations. A time interval can be understood to mean a time slot which is provided for processing a computing operation. In this respect, a time slot scheme in which several computing operations can alternately be executed sequentially in the computing unit in a temporally offset manner can be used during operation of the computing unit, wherein the individual computing operations are initially executed in different time slots. A completion time can be understood to mean a time at which the second computing operation has been completed in the second time interval. In this respect, the processing of the second computing operation does not take up the entire duration of the second time interval, so that the computing unit would no longer execute any processing of any computing operation in the second time interval from the completion time until the end of the second time interval.

The present invention is based on the finding that, for the most efficient utilization of the computing power available in the computing unit, time spans in which the computing unit does not execute any computing operation should not occur, if possible. In this respect, according to the present invention disclosed herein, it is provided to allow a computing operation other than the second computing operation (here the first computing operation) to be executed in a portion of the second time interval from the completion time to the end of the second time interval and thereby to suspend a very rigid time slot scheme in which individual computing operations can only be executed in the time slots or time intervals reserved for them. The approach presented here thus makes a significantly more continuous utilization of the computing unit possible, which leads to faster processing of the individual computing operations.

Particularly beneficial here is an example embodiment of the present invention which provides a step of storing an intermediate result of the first computing operation after the first time interval has elapsed, if the first computing operation could not be completed in the first time interval, wherein, in the step of executing, the first computing operation is further processed starting from the intermediate result from the completion time. In addition to a calculation result of the first computing operation, an intermediate result can also be understood to mean, for example, a state of the memory in which a processing instruction for the first computing operation is stored. Such an embodiment of the approach proposed here offers the advantage of efficiently processing the first computing operation in several time segments, since an interruption as error-free as possible of the processing of the first computing operation can be realized by storing the intermediate result (and subsequently loading this intermediate result in the second time interval at the completion time). The first computing operation therefore would not have to be started again, but instead can use calculation results that were ascertained in the computing unit in the first time interval.

According to a further embodiment of the present invention disclosed here, an auxiliary time interval in which at least a portion of the first and/or second computing operation can be processed can also be provided in the computing unit, wherein, in the step of executing, the processing of the second computing operation and/or the first computing operation is further processed without interruption in the auxiliary time interval after the second time interval has elapsed, in particular if processing of the second computing operation and/or the first computing operation has not yet been completed after the second time interval has elapsed. An auxiliary time interval can be understood to mean a time interval in which no computing operation is provided for processing. Rather, such an auxiliary time interval can be used to execute calculations of corresponding computing operations which are not yet completed. Such an embodiment of the approach proposed here offers the advantage of avoiding a complex and time-intensive loading of the computing unit with a processing instruction and/or intermediate results of a previously executed computing operation by further processing the second computing operation without interruption in the auxiliary time interval, which advantageously follows the second time interval.

Also beneficial is an example embodiment of the present invention disclosed here in which at least one further computing operation is furthermore processed in the computing unit, wherein a step of assigning is provided, in which the first, second and/or further computing operation are each assigned processing information, which represents information on processing of the relevant computing operation at a previous time. In this case, in the step of executing, the computing operation to be executed as the first computing operation is selected, taking into account the processing information, for processing in the second time interval. Processing information can be understood to mean information or a state which represents an indication of a degree of processing of the computing operation, a priority of the computing operation with respect to at least one other computing operation, a frequency of the processing of the corresponding computing operation in the computing unit or the like. Such an embodiment of the present invention disclosed here may offer an advantage of being able to make a very efficient selection of a computing operation, for example as the first computing operation, by taking into account the processing information, so that, for example, more important computing operations which have been processed to a minor extent or are to be executed more frequently can be processed with a higher priority in the computing unit.

According to a further embodiment of the present invention disclosed here, in the step of assigning, the processing information can be ascertained taking into account complete processing of the relevant computing operation at at least one previous time. Specifically, processing information that represents a lower prioritization for a renewed processing of the relevant computing operation at a subsequent time can in this case be assigned to the computing operation that has been completely processed at a previous time. Such an embodiment of the present invention disclosed here may offer the advantage of free portions of time intervals being primarily used to perform computing operations which, based on experience, take up a longer processing time. In this way, efficient and rapid processing of the totality of the computing operations to be executed can advantageously be achieved.

In addition, according to a further embodiment of the present invention disclosed here, in the step of assigning, the processing information for the first, second and/or further computing operation can be ascertained using a frequency of a previous processing of the relevant computing operation. Such an embodiment offers the advantage of allowing computing operations that are to be executed particularly frequently to be performed with priority in order, for example, to be able to quickly and reliably provide processing values of sensor data that are required on short notice and frequently. In this way, safety-critical computing operations or algorithms can also be reliably processed by the computing unit.

In order to be able to efficiently use a numerical power available in the computing unit, is also possible according to a further embodiment of the present invention to execute the further computing operation in the step of executing in the second time interval and/or the auxiliary time interval if the first computing operation has been completed in the second time interval and/or the auxiliary time interval. Such an embodiment offers the advantage of being able to execute more than one computing operation in the remaining portion of the second time interval and/or of the auxiliary interval so that the highest number possible of computing operations that are not yet completed can be processed while avoiding a rigid time slot scheme.

In order to avoid a complex decision on the computing operation to be specifically executed next when the prerequisites or decision criteria are almost the same, it is possible according to a further embodiment of the present invention to use a result of a random generator to execute, in the step of executing, the computing operation to be executed as the first computing operation, if the items of processing information assigned to the computing operations to be selected as a possible first computing operation are the same within a tolerance range.

According to a further embodiment of the present invention disclosed here, a particularly flexible embodiment for processing computing operations in a computing unit can be achieved in that, in the step of assigning, the processing information assigned to the computing operations is ascertained using an expected execution duration until the processing of the relevant computing operation in the computing unit is completed. In particular, in the step of executing, the computing operation of which the processing information corresponds to a longest execution duration until the processing of the relevant computing operation in the computing unit is completed can be selected as the first computing operation. In this way, excessively frequent and time-consuming reloading of the memory or processor of the computing unit with algorithms or intermediate results of the respective computing operations can be avoided, for example.

According to a further embodiment of the present invention disclosed here, the steps of the method can also be executed cyclically repeatedly, wherein, in the repeatedly executed steps, different calculation rules can be used as the first computing operation or different calculation rules can be used as the second computing operation. Such an embodiment offers the advantage of being able to execute different algorithms or processing instructions for a wide variety of purposes as the first and/or second computing operation in the computing unit, so that the available numerical performance of the computing unit can be used as optimally as possible.

In order, for example, to prevent a computing operation from being aborted in a time interval shortly before the processing is completed, it is also possible according to a further embodiment of the present invention disclosed here to execute the steps of the method repeatedly, wherein a step of changing a time length of the first and/or second time interval is executed before the repeatedly executed steps of the method.

Also advantageous is an embodiment of the present invention disclosed here in which, in the step of changing, the time length of the first and/or second time interval is changed at a later time depending on the first computing operation being completed in the first time interval and/or the second computing operation being completed at a previous time. Such an embodiment offers the advantage of being able to use temporally optimal time interval lengths for the corresponding computing operations and thus also to be able to complete the corresponding computing operations as much as possible within the respectively assigned time intervals.

This method of the present invention can be implemented, for example, in software or hardware or in a mixed form of software and hardware, for example in a control device.

The present invention disclosed herein further provides a device which is designed to carry out, actuate or implement the steps of a variant of a method presented here in corresponding apparatuses. The object of the present invention can also be achieved quickly and efficiently by this design variant of the present invention in the form of a device.

For this purpose, according to an example embodiment of the present invention, the device can have at least one computing unit for processing signals or data, at least one memory unit for storing signals or data, at least one interface to a sensor or an actuator for reading sensor signals from the sensor or for outputting data signals or control signals to the actuator, and/or at least one communication interface for reading or outputting data embedded in a communication protocol. The computing unit can, for example, be a signal processor, a microcontroller or the like, wherein the memory unit can be a flash memory, an EEPROM, or a magnetic memory unit. The communication interface can be designed to read or output data wirelessly and/or in a wired form, a communication interface, which can read or output wired data, being able to read these data, for example electrically or optically, from a corresponding data transmission line, or being able to output these data into a corresponding data transmission line.

In the present case, a device can be understood to be an electrical device that processes sensor signals and, on the basis of these signals, outputs control and/or data signals. The device can have an interface that can be designed as hardware and/or software. In a hardware embodiment, the interfaces can, for example, be part of a so-called system ASIC, which contains a wide variety of functions of the device. However, it is also possible for the interfaces to be separate integrated circuits or at least partially consist of discrete components. In the case of a software embodiment being used, the interfaces can be software modules that are present, for example, on a microcontroller in addition to other software modules.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the embodiments of the present invention described above is advantageous as well, in particular when the program product or program is executed on a computer or a device.

Exemplary embodiments of the present invention disclosed here are illustrated in the figures and explained in more detail in the following description.

### BRIEF DESCRIPTION OF THE DRAWINGS

FIG. 1 shows a schematic representation of a vehicle in which a device 105 according to an exemplary embodiment of the present invention disclosed here is installed.

FIG. 2 shows a schematic representation of the time curve t during the processing of computing operations according to an exemplary embodiment of the present invention disclosed here.

FIG. 3 shows a block circuit diagram of a device for processing according to an exemplary embodiment of the present invention.

FIG. 4 shows a flowchart of a method according to an exemplary embodiment of the present invention.

### DETAILED DESCRIPTION OF EXAMPLE EMBODIMENTS

In the following description of advantageous exemplary embodiments of the present invention, the same or similar reference signs are used for the elements shown in the various figures and acting similarly, as a result of which a repeated description of these elements is omitted.

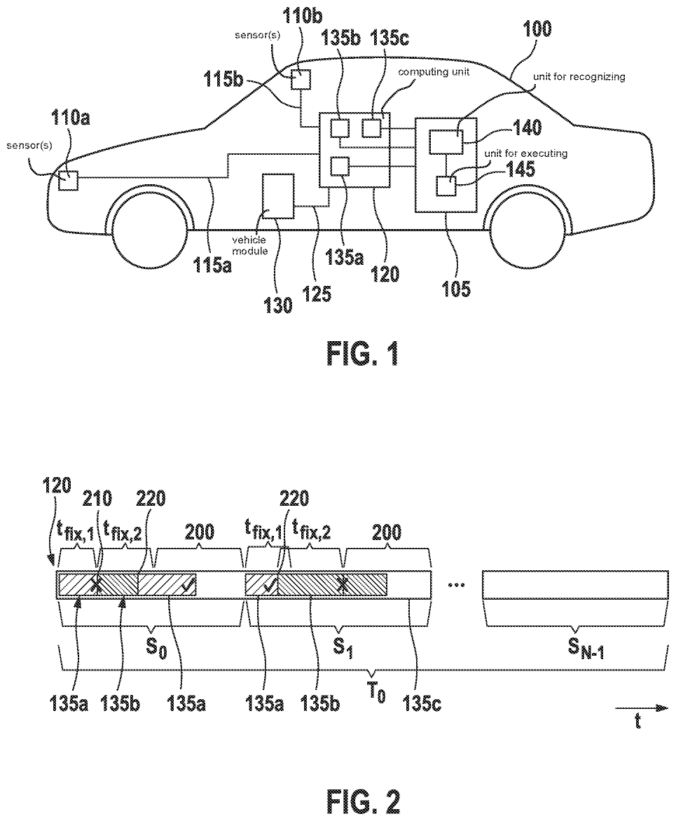

FIG. 1 shows a schematic representation of a vehicle 100, in which a device 105 according to an exemplary embodiment of the approach presented here is installed. Furthermore, one or more sensors 110a and 110b are, for example, also installed in the vehicle 100, which sensors transfer their sensor data 115a and 115b to a computing unit 120, in which these sensor data 115a and 115b are processed and, for example, a control signal 125 is formed, which controls a vehicle module 130. The vehicle module 130 can, for example, be a driver assistance system or a safety system of the vehicle 100, for example an airbag system or an anti-lock braking system (ABS).

In order now to correctly ascertain the control signal 125, the sensor data 115a or 115b are linked or processed in a wide variety of ways in the computing unit 120, which is often designed as a microprocessor or control, wherein a corresponding computing operation, such as a first computing operation 135a, a second computing operation 135b, and/or a third computing operation 135c, is to be executed as a corresponding task in the computing unit 120 for each such linking or processing. Especially for rapid processing of algorithms that are often time-critical and safety-critical for the driving safety of the vehicle 100, efficient processing of the corresponding computing operations 135a, 135b, and 135c is required in the computing unit 120. The temporal execution or processing of the corresponding computing operations 135a, 135b and/or 135c in the computing unit 120 is in this case controlled, according to the approach presented here, by an exemplary embodiment of the device 105 for processing at least a first computing operation 130a and a second computing operation 135b in the computing unit 120.

In order to fulfill this task, the device 105 for processing at least a first 135a and a second 135b computing operation in a computing unit 120 has a unit 140 for recognizing and a unit 145 for executing the first computing operation 135a in the second time interval after a completion time. In this case, the device 105 for processing is designed to process the first computing operation in the computing unit in a first time interval and to process the second computing operation in the computing unit in a second time interval different from the first time interval. In the unit 140 for recognizing, it is recognized that the second computing operation has been completed in the second time interval at the completion time before an end of the second time interval. In the unit 145 for executing, the memories and/or the processor are loaded with the data or corresponding processing instructions in order to execute the respectively corresponding computing operation 135a, 135b or 135c in the computing unit 120.

FIG. 2 shows a schematic representation of the time curve t during the processing of computing operations according to an exemplary embodiment of the approach presented here. It can be seen here that several subcycles S₀, S₁, . . . , S_{N-1} are contained in a cycle time T₀. In each of these subcycles S₀, S₁, . . . , S_{N-1}/time intervals for processing the individual computing operations are now provided again. For example, a first time interval t_{fix,1} is provided for processing the first computing operation 135a, while a second time interval t_{fix,2} is provided for processing the second computing operation 135b. In this exemplary embodiment, an auxiliary time interval 200 is also provided, which lasts the time duration after the end of the second time interval t_{fix,2} until the temporal end of the first subcycle S₀. In the auxiliary time interval 200, depending on the urgency or requirement, any computing operations can be executed in the computing unit 120 so that, for example, both the first computing operation 130a and the second computing operation 135b or the further computing operation 135c can be executed in this auxiliary time interval.

The device 105 for processing is designed to load the memories or processor of the computing unit 120 with data in such a way that the first computing operation 135a can be executed in the first time interval. As can be seen from the representation of FIG. 2, the processing of the first computing operation 135a is not yet completed at the end of the first time interval and must thus be interrupted. For this case, an intermediate result 210 is now stored, for example, in a memory (not shown in the figures) of the computing unit or of the device 105, wherein this intermediate result, for example, is formed or represents, on the one hand, a preliminary calculation result of the first computing operation and/or a memory/register assignment of the memory or of registers of the processor of the computing unit 120 so that the first computing operation 135a can be resumed as free of errors as possible at a later time. In the second time interval following the first time interval, the second computing operation 135b is now executed first. However, as can be seen in FIG. 2, the calculation of the second computing operation 135b is completed at a completion time 220, which is before the end of the second time interval, so that the computing unit 120 is no longer required for carrying out the second computing operation 135b in the time segment of the second time interval between the completion time 220 and the end of the second time interval and is available for other tasks. According to the approach presented here, the memory or processor of the computing unit 120 can now again be loaded with the data of the intermediate result 210 and the first computing operation 135a can be continued. As a result, the most efficient use of the numerical power available in the computing unit 120 can be used for rapid processing of the computing operations 135. Furthermore, after completion of the second time interval, it is, for example, also possible in the following auxiliary time interval 200 to process that computing operation (here the first computing operation 135a), so that a time-consuming change of the data or processing instructions stored in the computing unit 120 can be avoided as much as possible and further acceleration of the processing of the computing operations 135 can thus be achieved.

If no further computing operation is now pending for processing, the computing unit 120 can be unused in the remaining time span of the auxiliary time interval 200. Alternatively, it is of course also possible, for example, to execute the further computing operation 135c in this remaining time span of the auxiliary time interval 200, but this is not explicitly shown in FIG. 2.

An analogous procedure of controlling the execution or processing of computing operations in the computing unit 120 can also be shown with respect to the subcycle S₁. In this case, the first computing operation 135a is now processed in the first time interval and finished at the completion time 220 before the first time interval has ended. For the most efficient use of the computing unit 120, the second computing operation 135b can now already be started directly in the first time interval and is then also further processed without interruption in the second time interval following the first time interval, and even directly in the auxiliary time interval 200. In this way, very efficient control of the processing of the computing operations in the computing unit 120 can be made possible.

If, in turn, there is no longer a need for processing the first computing operation 135a or the second computing operation 135b in the auxiliary time interval 200, the computing unit 120 can also again remain unused in this auxiliary time interval or the further computing operation 135c can be processed.

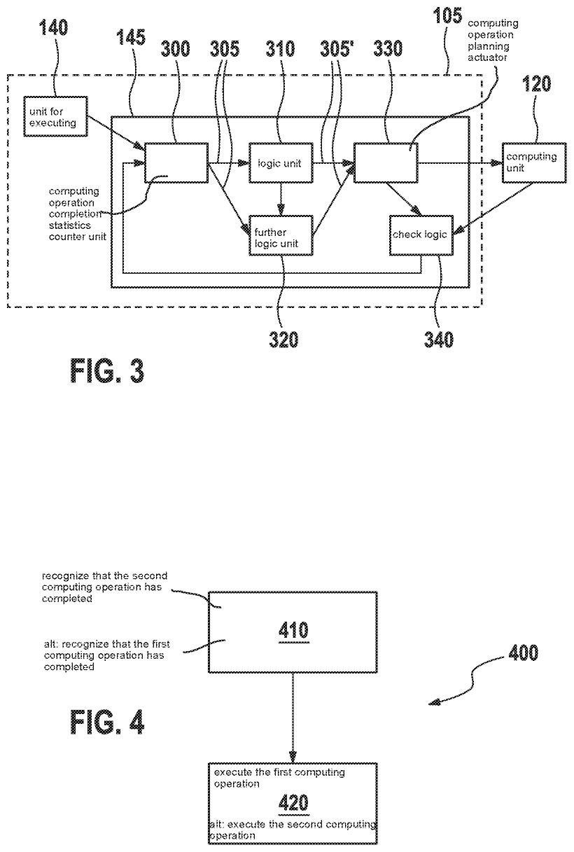

FIG. 3 shows a block circuit diagram of a device 105 for processing according to an exemplary embodiment. Here, the device 105 for processing comprises the unit 140 for recognizing and the unit 145 for executing. For example, in the unit 140 for recognizing, it is recognized that a computing operation, such as the first computing operation 135a, the second computing operation 135b, and/or the further computing operation 135c, has been completed or reserved for execution in a following time slot, wherein this result is now transferred to the unit 145 for executing. The unit 145 for executing now acts like a unit for planning a free time budget of the computing unit 120, i.e., for planning which computing operation is to be executed from a completion time 220 until the end of the relevant time interval and/or in the auxiliary time interval 200. For this purpose, it is first detected in a computing operation completion statistics counter unit 300 which computing operation has been completed how often. A result of this unit 300 which represents processing information 305 is subsequently transferred into a logic unit 310, which selects the next computing operation. Optionally, the result or the processing information 305 of this unit 300 is supplied to a further logic unit 320, which can ascertain how long or which time interval is allocated to a subsequent execution of a corresponding computing operation. Processed processing information 305′ from the logic unit 310 and from the further logic unit 320 is then supplied to a computing operation planning actuator 330, which assigns corresponding registers or memories in the computing unit 120 in order to be able to carry out, in the computing unit 120, a correspondingly selected computing operation to be executed. At the same time, the computing operation planning actuator 330 communicates whether or which computing operation has been loaded into the computing unit 120, to a check logic 340 for checking completed processing of a computing operation. At the same time, the check logic 340 monitors the processing of the computing operation in the computing unit 120. If it is determined in the check logic 340 that the computing operation to be executed in the computing unit 120 is completed, this result is in turn communicated to the unit 300, which logs the execution of the corresponding computing operation in the computing unit 120 and provides corresponding information for a new cycle of the processing of a computing operation in the processing unit 120 to the logic unit 310 or the further logic unit 320.

FIG. 4 shows a flowchart of an exemplary embodiment of a method 400 for processing at least a first and a second computing operation in a computing unit. In this case, a first time interval is provided for processing the first computing operation in the computing unit and a second time interval different from the first time interval is provided for processing the second computing operation in the computing unit. The method 400 comprises a step 410 of recognizing that the second computing operation has been completed in the second time interval at a completion time before an end of the second time interval. The method 400 furthermore comprises a step 420 of executing the first computing operation in the second time interval after the completion time. In addition or as an alternative, the method 400 comprises a step 410 of recognizing that the first computing operation has been completed in the first time interval at a completion time before an end of the first time interval. Finally, the method 400 comprises a step 420 of executing the second computing operation in the first time interval after the completion time.

Below, the approach presented here can again be summarized in other words or amended or continued. The approach presented here can be understood as a cycle-optimized soft-real-time scheduler for assigning various computing operations to a computing unit.

It should be mentioned first in this case that systems with real-time requirements are characterized in that a plurality of tasks is cyclic in nature, e.g., the recurring calculation of object data on the basis of sensor data, which are regularly supplied externally. In a soft-real-time system, it is also regularly not relevant that a task can be completed in each cycle, but rather that the task can be fully completed a particular number of times in a larger time interval. In each cycle, the task starts anew, for example, because new sensor data are available, for example.

Since the runtime of the individual task can be subject to external influences (e.g., given by the complexity of a scene to be processed), the budget planning represents a special challenge. Worst-case estimates are regularly made, which, however, lead to the budgets being selected to be too large in practice. As a result, all tasks are fully processed to the end with high certainty in each cycle. In order nevertheless to ensure efficient resource use, unused budget portions are made available to other tasks to ensure work load preservation. However, since the initial system design has already provided a high probability of completing the tasks, this excess remains unused. The mere redistribution of excess budget is thus successful only to a limited extent in making a more appropriate system design (e.g., by choice of a weaker CPU) for the tasks possible.

A basic idea of the proposal presented here can be seen in that the approach presented here makes the efficient redistribution of unused shared resources to fulfill soft-real-time requirements possible. Soft-real-time requirements are defined in this context as the completion of a recurring resource-using task (task or computing operation), which, for example, should be fully completed a particular number of times in a particular time interval.

In this case, a task has an unknown dynamic runtime t_{dyn} until completion (time), which depends on external factors (e.g., amount of available sensor data). In this case, the focus of the approach presented here (success criterion of the soft-real-time scheduler as the device 105) is that the task or computing operation is, for example, completed successfully at least Nₘᵢₙ times within a time interval T₀. The time period T₀ is divided into N>=Nₘᵢₙ time intervals (or subcycles) with duration S_{i,0}<=i<N, within which the task is to be executed fully from beginning to end in each case. The duration of the internal intervals or subcycles Sᵢ is, for example, determined by the availability of new data packets, for example sensor data packets. In each interval, there are generally several tasks or computing operations that compete for the resource allocation.

A basic idea of the approach presented here is the determination of a fixed runtime budget t_{fix} per execution of the task per time interval Sᵢ, which is smaller than the dynamic runtime t_{dyn} with a non-negligible statistical probability. The runtime budget is in this case the guarantee budget that the task is accomplished in any case. Dimensioning t_{fix} to be correspondingly large in order to cover all realizations of t_{dyn} is inefficient.

If the task is not completed when the runtime budget t_{fix} is used up, the state of the task (for example in the form of the intermediate result 210) is obtained. Thereafter, a different task or a different computing operation 135b is executed with the remaining budget (preemption). Per time interval, there are several ready-to-execute tasks, which can respectively use the shared resource up to the limit of their fixed runtime budget. If all tasks either are completed or have consumed their budget, a central instance (free budget scheduler as the device 105) decides on the distribution of the remaining time budget within the time interval or subcycle Sᵢ. In general, Sᵢ>Σt_{fix,j} applies. A focal point of the approach presented here is the selection of the tasks or computing operations that are brought to execution again in the remaining time budget in order to potentially cover their dynamic runtime needed t_{dyn}. For this purpose, a counting statistic and an algorithm, for example, are proposed, which in a prioritized manner selects the task for which the probability that it does not run to completion at least Nₘᵢₙ times within the interval T₀ is the highest.

Several aspects can be given as advantages of the approach presented here.
1. The approach presented here is suitable for explicitly taking into account long-term quality criteria for schedulers or the device 105 (minimum number of full executions of a task or of a computing operation).
2. The approach presented here makes efficient resource utilization (work preservation) possible since the shared resource can be fully used within a cycle.
3. The approach presented here is particularly suitable for cyclic tasks with alternating load or (numerical) load, as occur, for example, in sensor fusion tasks in highly automated driving.
4. The approach presented here can be combined with other scheduling mechanisms within the individual time subintervals, for example in order to improve the response time (time to completion of the computing operation).
5. The decision algorithm proposed here can be adapted based on the use case.
6. The approach presented here can initially be provided for scheduling a computer unit or CPU but can also be used for other shared resources.

Specifically, in FIG. 2, an exemplary embodiment for a distribution of the free budget on the basis of the task completion is described in more detail. According to one exemplary embodiment, the proposed scheduler decides on the distribution of unused remaining runtime within a time interval Sᵢ. In this case, the scheduler takes into account, for example, only the tasks or computing operations that have not yet been completed, i.e., that have completely consumed their budget without finishing the task. The scheduler can, for example, recognize this by the fact that the tasks were respectively preempted, i.e., that, as part of using up the runtime budget, the task was necessarily replaced by another task in the CPU or computing unit 120.

Specifically, with reference to FIG. 3, individual components of the free budget scheduler are explained in more detail, which here represents a specific form of the device 105 for processing.

For example, in a computing operation completion statistics counter unit 300 [task completion statistics counter], a simple counting statistic first increments a task-specific integer counter for each task (=computing operation) that has not run to completion. If the task is now selected and can be completed by using the remaining budget in the time interval Sᵢ, the counting statistic is decremented. More complex statistics that, for example, take into account gradual incrementing/decrementing or the application of a sliding window are possible. For tasks that are completed within their fixed runtime budget, the counter is either reset or decremented, for example. The latter would have advantages in the case of cyclic load scenarios.

In a logic unit 310, which selects the next computing operation [next task selection logic], a selection can now, for example, take place in different ways due to the counting statistic. The following procedures for the assignment of the registers and memories of the computing unit 120 can therefore be selected in this logic unit, wherein the numerical steps, for example, indicate the order and the letters indicate alternatives. Values in parentheses relate, for example, to a reference to the previous step:
1a. In principle, the task that has the highest counter value is selected.
1b. A task is selected with a probability weighted according to the statistic, i.e., tasks with higher counter values are selected with higher probabilities.
2a (1a). If two or more tasks have the same counter value, a random number generator is used to select the task that is to run or be executed in the computing unit 120.
2b (1a). If two or more tasks have the same counter value, the task that could not be successfully completed for the longest time (within the meaning of the time intervals S) is selected. If this applies to several tasks, (2a) or (2c) can be applied.
2c (1a). If two or more tasks have the same counter value, the first task is selected according to the order in the list of the counting statistic. However, this option can lead to suboptimal results under the boundary conditions of the fixed runtime budgets being exceeded in a correlated manner.

In a further logic unit 320, it can, for example, be ascertained how long or which time interval is assigned to a subsequent execution of a corresponding computing operation [task run duration budget logic]. For example, a decision on the duration of the execution can thus be made as follows:
3a. The selected task is allowed to run to completion, i.e., until completion time, and its counter value is decremented.
3b. The selected task is only allowed to run for a fixed extended period. In this case, the length of the period is, for example, selected according to the weighting in the execution statistic. For example, it is possible to allow a task to run longer if the task was not completed in the past despite the free budget scheduler.

In a check logic 340 for checking completed processing of a computing operation [task completion check logic], the task statistic can, for example, be recognized after the end of the extended execution and updated in the computing operation completion statistics counter unit 300, and the next task can be selected. This is repeated until either all tasks for this time interval have been successfully completed or the time interval has elapsed.

Possible alternatives of the approach presented here are also possible. For example, extensions can be provided as follows:
1. Replacing tasks by task containers, i.e., several tasks are combined into a task container. They share the same runtime budget and are treated equally during the selection. The internal logic of the containers, i.e., which task of the task container is assigned the resource, is to be decided within the scope of a container-specific scheduler.
2. Partitioning of the free budget. Further limits for selecting the tasks and their use of the remaining budget can be imposed. It can thus be defined that a task can only use the unused budget of one other task or one group of other tasks. This interconnection increases the mutual FFIs of tasks with different guarantee requirements.
3. If a critical number of missed completions occur in the case of individual tasks, it is possible within the scope of slot stealing that the runtime budget of other tasks, which so far have consistently complied with their deadlines, is violated once and that completion of the critical task is thus allowed. However, this variant assumes that tasks can be categorized as hard-real-time (violation is not acceptable) and soft-real-time (see above) in the scheduler.

A procedure presented here, for example, has potential to be used in a vehicle computer with tasks in the ADAS environment. In such a system, dynamic loads often occur, e.g., due to the different complexity of the vehicle environment. However, the processes provided allow a soft-real-time realization in which tasks can have deadline violations up to an acceptance limit.

The following aspects may become important in this case:
(a) A mixture of tasks with hard-real-time requirements and soft-real-time requirements is not to be provided.
(b) It is not necessary to guarantee that tasks are started at a particular time.
(c) Desynchronization of dependent tasks in distributed systems may occur over time.

In this sense, the approach presented here is a new solution for an existing problem. The mixture of hard-real-time and soft-real-time systems is a new technical task field, which arose only with the appearance of tasks with dynamic input variables (e.g., the number of objects to be recognized in an environmental sensor system). Although it is possible to operate systems with mixed tasks, computing power is provided correspondingly (inefficiently) there in order to allow renormalization to a hard-real-time system.

Derived therefrom, it can at least be assumed
(a) that this does not seem to be a trivial task, since there are not yet any solutions the related art; and
(b) that this is a new field with a correspondingly low number of previous solutions so that new approaches fundamentally have a certain value.

If an exemplary embodiment has an “and/or” link between a first feature and a second feature, this is to be understood to mean that the exemplary embodiment according to one example has both the first feature and the second feature and, according to a further exemplary example, either only the first feature or only the second feature.

1-15. (canceled)

16. A method for processing at least a first and a second computing operation in a computing unit, wherein a first time interval is provided for processing the first computing operation in the computing unit and a second time interval different from the first time interval is provided for processing the second computing operation in the computing unit, the method comprising the following steps:
(i) performing:
recognizing that the second computing operation has been completed in the second time interval at a completion time of the second computing operation before an end of the second time interval, and
executing the first computing operation in the second time interval after the first completion time of the second computing operation; and/or
(ii) performing:
recognizing that the first computing operation has been completed in the first time interval at a completion time of the first computing operation before an end of the first time interval, and
executing the second computing operation in the first time interval after the completion time of the first computing operation.

17. The method according to claim 16, comprising:
storing an intermediate result of the first computing operation after the first time interval has elapsed, when the first computing operation could not be completed in the first time interval, wherein, in the step of executing, the first computing operation is further processed starting from the intermediate result from the completion time of the second computing operation.

18. The method according to claim 16, wherein an auxiliary time interval is also provided in the computing unit in which auxiliary time interval at least a portion of the first and/or second computing operation can be processed, wherein, in the step (420) of executing, the processing of the second computing operation and/or the first computing operation is further processed without interruption in the auxiliary time interval after the second time interval has elapsed, when the processing of the second computing operation and/or the first computing operation has not yet been completed after the second time interval has elapsed.

19. The method according to claim 16, wherein at least one further computing operation is also processed in the computing unit, wherein a step of assigning is provided, in which at least one relevant one of the first and/or the second and/or the further computing operation are each assigned processing information, which represents information on processing of the relevant computing operation at a previous time, wherein, in the step of executing, a computing operation to be executed as the first computing operation is selected, taking into account the processing information, for processing in the second time interval.

20. The method according to claim 19, wherein, in the step of assigning, the processing information is ascertained taking into account a complete processing of the relevant computing operation at at least one previous time, wherein the relevant computing operation that has been completely processed at a previous time is assigned processing information that represents a lower prioritization for a renewed processing of the relevant computing operation at a subsequent time.

21. The method according to claim 19, wherein, in the step of assigning, the processing information for the first, and/or the second and/or the further computing operation is ascertained using a frequency of a previous processing of the relevant computing operation.

22. The method according to claim 19, wherein, in the step of executing, the further computing operation is executed in the second time interval and/or the auxiliary time interval when the first computing operation has been completed in the second time interval and/or the auxiliary time interval.

23. The method according to claim 19, wherein, in the step of executing, a result of a random generator is used to execute the computing operation to be executed as the first computing operation when the items of processing information assigned to the computing operations to be selected as a possible first computing operation are the same within a tolerance range.

24. The method according to claim 19, wherein, in the step of assigning, the processing information assigned to the computing operations is ascertained using an expected execution period until the processing of the relevant computing operation in the computing unit is completed, and wherein, in the step of executing, that computing operation the processing information of which corresponds to a longest execution duration until the processing of the relevant computing operation in the computing unit is completed is selected as the first computing operation.

25. The method according to claim 16, wherein the steps of the method are executed cyclically repeatedly, wherein, in the repeatedly executed steps, different calculation rules can be used as the first computing operation or different calculation rules can be used as the second computing operation.

26. The method according to claim 16, wherein the steps of the method are executed repeatedly, wherein a step of changing a time length of the first and/or second time interval is executed before the repeatedly executed steps of the method.

27. The method according to claim 26, wherein, in the step of changing, the time length of the first and/or the second time interval is changed depending on the first computing operation being completed in the first time interval and/or the second computing operation being completed.

28. A device configured to for processing at least a first and a second computing operation in a computing unit, wherein a first time interval is provided for processing the first computing operation in the computing unit and a second time interval different from the first time interval is provided for processing the second computing operation in the computing unit, the device configured to:
(i) perform:
recognizing that the second computing operation has been completed in the second time interval at a completion time of the second computing operation before an end of the second time interval, and
executing the first computing operation in the second time interval after the first completion time of the second computing operation; and/or
(ii) perform:
recognizing that the first computing operation has been completed in the first time interval at a completion time of the first computing operation before an end of the first time interval, and
executing the second computing operation in the first time interval after the completion time of the first computing operation.

29. A non-transitory machine-readable storage medium on which is stored a computer program for processing at least a first and a second computing operation in a computing unit, wherein a first time interval is provided for processing the first computing operation in the computing unit and a second time interval different from the first time interval is provided for processing the second computing operation in the computing unit, the computer program, when executed by a computer, causing the computer to perform the following steps:
(i) performing:
recognizing that the second computing operation has been completed in the second time interval at a completion time of the second computing operation before an end of the second time interval, and
executing the first computing operation in the second time interval after the first completion time of the second computing operation; and/or
(ii) performing:
recognizing that the first computing operation has been completed in the first time interval at a completion time of the first computing operation before an end of the first time interval, and
executing the second computing operation in the first time interval after the completion time of the first computing operation.
